(19) United States
(12) Patent Application Publication
(10) Pub. No.: US 2022/0298809 A1
(43) Pub. Date: Sep. 22, 2022

(54) HAND TOOL ASSEMBLED USING COUNTERSUNK SHANK AND METHOD OF MANUFACTURE

(71) Applicant: Bon Tool Company, Gibsonia, PA (US)

(72) Inventors: C. John Bongiovanni, Pittsburgh, PA (US); Giovanni Provenzano, Allison Park, PA (US)

(21) Appl. No.: 17/205,040

(22) Filed: Mar. 18, 2021

(51) Int. Cl. E04F 21/16; B25G 3/34; B25G 3/36; B24B 19/00; E04F 21/24

(52) U.S. Cl. CPC E04F 21/161; B25G 3/34; B25G 3/36; B24B 19/007; E04F 21/241

(57) ABSTRACT

A hand tool. The hand tool includes the hand tool includes a shank, a handle attached to the shank, and a finishing element attached to the shank. The finishing element is attached to the shank by one or more fasteners. The fasteners extend substantially through a hole in the finishing element and an aligned hole in the shank to affix the finishing element to the shank. The fastener has a first expanded end situated in a countersink in an exposed surface of the shank.

### BACKGROUND OF THE INVENTION

Certain construction tools, such as masonry and concrete finishing hand tools and drywall and plaster finishing hand tools, include a handle and finishing element such as a blade, bit, or shaping element. The handle typically has a finishing element coupling surface called a shank that attaches the handle to the finishing element and a hand grip for holding the tool. The finishing element typically has an operating surface that moves, shapes, or otherwise contacts a material during operation and a handle coupling surface, often opposite the operating surface. For example, a trowel may include a handle affixed to a blade for placing, smoothing or otherwise shaping unhardened mortar, concrete, plaster, or other materials. Other tools, often those having extended handles, include a handle coupling bracket coupled to the handle coupling surface of a finishing element. An extended handle shank may then be coupled to the bracket.

Such handle shanks and handle coupling brackets may be coupled to the handle coupling surface of the finishing element using rivets. Those rivets generally extend through the finishing element and are exposed in the operating surface of the finishing element. Such rivets can create ridges or bumps or other undesirable imperfections in the operating surface.

In certain applications, for example where the handle coupling surface of the finishing element is not flat, an intermediate plate is riveted to the finishing element and the handle or handle coupling bracket is attached to the intermediate plate. The handle or handle coupling element is typically coupled to the intermediate plate by rivets or screws.

In a typical riveting process, holes are drilled or punched through the finishing element and the handle shank and, where they are used, possibly, a handle coupling bracket, or intermediate plate. The operating surface of the finishing element is sometimes countersunk at each hole to prevent the rivet from extending past the operating surface. Rivets are then placed through the holes and set. Smoothing or finishing may then be performed on the rivet and the operating surface where the rivet contacts the coupling surface to smooth that surface. It is not unusual for such rivets to pull out of the tool, often from the handle side of the shank, because those rivets do not have a good purchase on the handle shank due to a lack of gripping surface area on the handle shank.

Thus, there may be a need for a hand tool having an improved attachment technique, particularly with regard to attachment to the handle shank. There may also be a need for a masonry hand tool having a handle attached to a finishing element in a way that does not include one or more rivets, which may have rough or sharp ends, extending through the handle shank toward the hand of a user.

### SUMMARY OF THE INVENTION

Embodiments of hand tool disclosed herein are directed to apparatuses and methods for attaching a handle to a hand tool using countersinks to increase attachment strength or to reduce harm to a user.

In accordance with one embodiment of an improved hand tool, the hand tool includes a shank, a handle attached to the shank, and a finishing element attached to the shank. The finishing element is attached to the shank by one or more fasteners. The fasteners extend substantially through a hole in the finishing element and an aligned hole in the shank to affix the finishing element to the shank. The fastener has a first end situated in a countersink in an exposed surface of the shank, the fastener expanded to be wider than the shank hole through which the fastener extends.

In accordance with another embodiment of an improved hand tool, the hand tool is a trowel that includes a handle, a trowel blade, and a shank. The shank is attached to the trowel blade and the handle is attached to the shank by interference fit. The shank has an exposed surface facing the handle and facing away from the trowel blade. A plurality of rivets affixes the trowel blade to the shank: each rivet extending substantially through a hole in the trowel blade and extending substantially through an aligned hole in the shank, each rivet having a first expanded end situated in a trowel blade countersink formed in an operative surface of the trowel blade coaxial with one of the holes in the trowel blade such that each of the plurality of rivets does not extend past the operative surface of the trowel blade. Each rivet also has a second expanded end situated in a shank countersink in an exposed surface of the shank, coaxial with one of the holes in the shank, such that each of the plurality of rivets does not extend past the exposed surface of the shank.

In accordance with an embodiment of a method of affixing a handle shank to a trowel blade: a plurality of countersinks is created in an exposed surface of a handle shank, wherein each countersink is concentric with one of a plurality of holes extending from the exposed surface to an opposed surface; the plurality of holes in the handle shank are aligned with a plurality of holes in a trowel blade with the shank countersinks exposed; a plurality of rivets is placed through the aligned handle shank holes and trowel blade holes so that each rivet extends through one of the handle shank holes and one of the trowel blade holes; and a first end of each of the plurality of rivets is compressed into the countersink in each of the plurality of holes in the handle shank. The first end of each of the plurality of rivets is then ground so that the rivets do not extend past the exposed surface of the handle shank and, in certain embodiments, until each rivet is even with the exposed surface of the handle shank.

Accordingly, the present invention provides solutions to the shortcomings of prior hand tools, including trowels. Those of ordinary skill in the art will readily appreciate, therefore, that those and other details, features, and advantages of the present invention will become further apparent in the following detailed description of the preferred embodiments of the invention.

### BRIEF DESCRIPTION OF THE DRAWINGS

The detailed description is better understood in conjunction with the accompanying drawings, in which like reference characters represent like elements, as follows:

FIG. 1 is an isometric top view of a trowel in an embodiment of a hand tool assembled using double-countersinks;

FIG. 2 is a rear view of the trowel of FIG. 1;

FIG. 3 is a side view of the trowel of FIGS. 1 and 2;

FIG. 4 is a top view of the trowel of FIGS. 1-3 prior to attachment of a handle;

FIG. 5 is a bottom view of the trowel of FIGS. 1-4;

FIG. 6 illustrates a detail side view cutaway of a shank and finishing element at a fastener hole; and

FIG. 7 shows a method of affixing a handle shank to a blade of the trowel.

### DETAILED DESCRIPTION

Reference will now be made to embodiments of hand tools assembled using double countersinks and methods of assembling hand tools using double countersinks, examples of which are illustrated in the accompanying drawings. Details, features, and advantages of the hand tools and methods of assembling hand tools will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

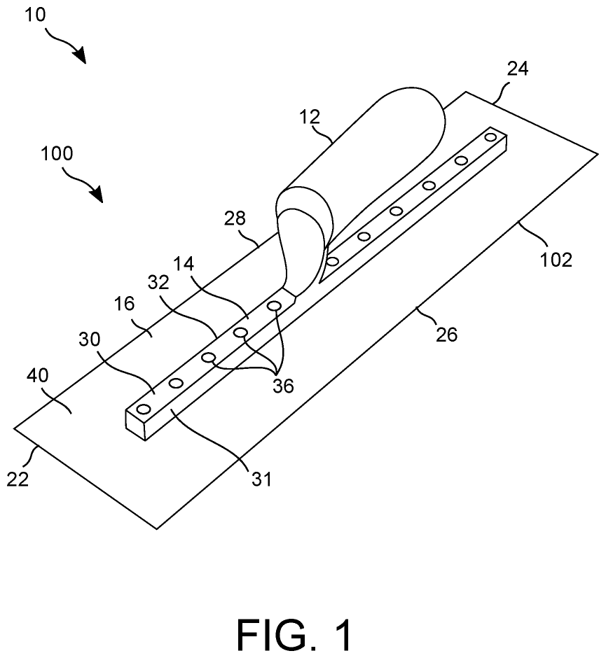

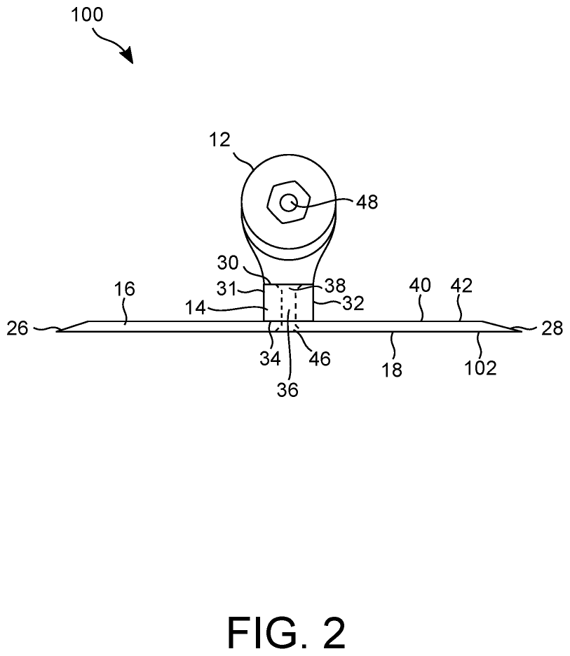

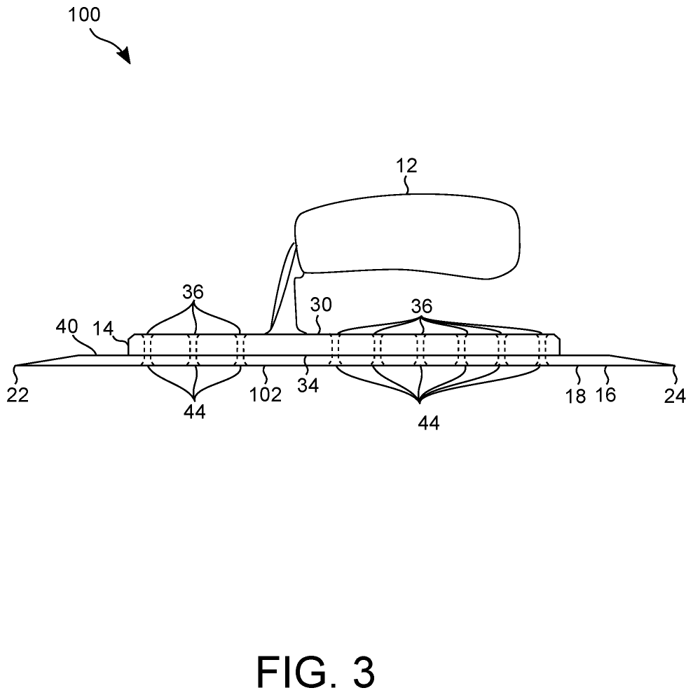

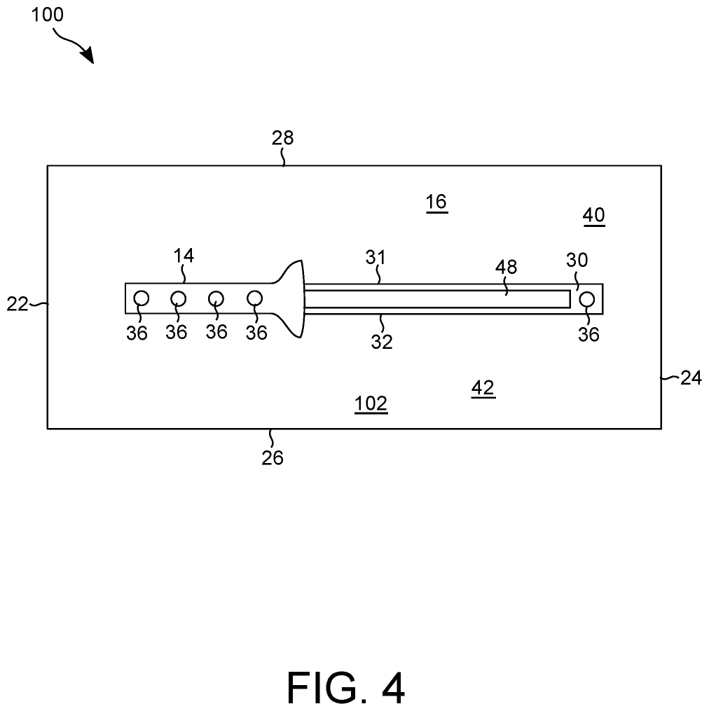

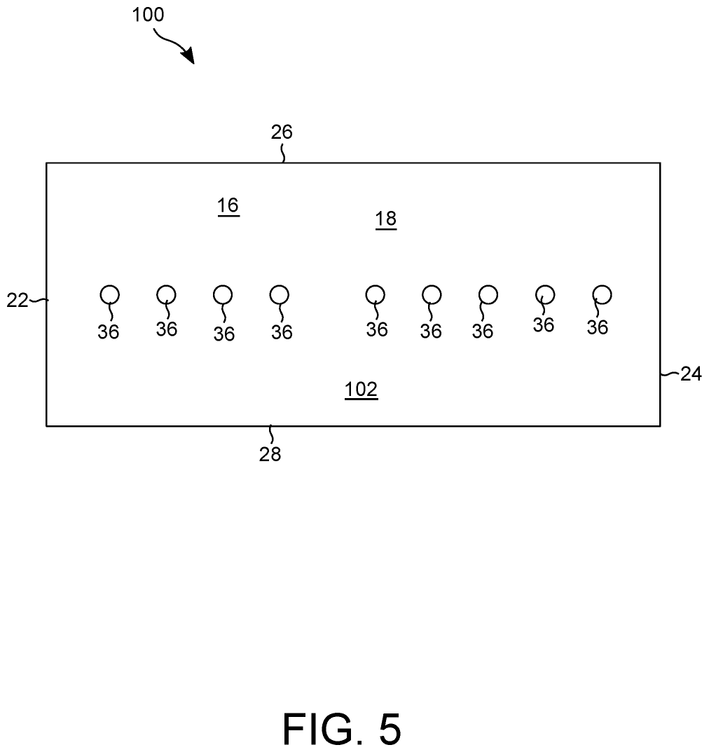

FIGS. 1-5 illustrate views of an embodiment of a hand tool 10 having a handle 12 coupled to a finishing element 16 using double countersinks. The hand tool 10 illustrated in FIGS. 1-5 is a finishing trowel 100. FIG. 1 is an isometric view of a handle side of the finishing trowel 100, illustrating countersinks in a handle 12 shank 14. FIG. 2 is a rear view of the finishing trowel 100 of FIG. 1. FIG. 3 is a side view of the finishing trowel 100 of FIGS. 1 and 2. FIG. 4 is a top view of the finishing trowel 100 of FIGS. 1-3 with no handle 12 attached thereto. FIG. 5 is a bottom view of the finishing trowel 100 of FIGS. 1-5, illustrating an operational side 18 of the finishing element 16.

The hand tool 10 of FIGS. 1-5 includes a unitary finishing element 16, here a trowel body or trowel blade 102, for placing, spreading or smoothing concrete or other compounds. Other compounds to be manipulated by the trowel blade 102 may include masonry compounds or non-masonry compounds, floor leveler, plaster and wall compounds, stucco and other exterior wall material, and various filling and coating compounds including those used on floors and walking surfaces, walls, and other construction surfaces whether interior or exterior.

The finishing element 16 depicted in FIGS. 1-5, in the form of a trowel blade 102, has an operational surface 18 and a handle attachment side 42. The finishing element 16 also includes one or more holes 44 extending from the operational surface 18 to the handle attachment side 42. Each of those holes 44 in the finishing element 16 may include a countersink 46 at the operational surface 18 of the finishing element 16.

The handle 12 may be situated in the same or a similar plane with the shank 14 and the finishing element 16, as illustrated in FIGS. 1-3, or be angled from the finishing element 16 or otherwise positioned or disposed as desired. The handle 12 may be attached to the shank 14 by an interference fit over a shank handle coupler 48. Alternatively, the handle 12 may be attached to the shank 14 by screws or other fasteners 20, or by other fastening techniques that attach the handle 12 to the shank handle coupling 48.

The shank 14 illustrated in FIGS. 1-5 is a rectangular cross-sectional shaped metal bar that may be chamfered, beveled, or smoothed at its corners. That shank 14 has an exposed side 30, two side surfaces 31 and 32, and an adjacent side 34 that rests against the finishing element 16, the exposed side facing away from the finishing element 16 and toward the handle 12. That shank 14 also includes one or more holes 36 extending from the exposed side 30 to the adjacent side 34. Each of those holes 36 in the shank 14 may include a countersink 38 at the exposed side 30 of the shank 14.

The shank 14 illustrated in FIGS. 1 3, and 4 is affixed to the body or trowel blade 102 by a plurality of rivets 50 extending through holes 36 in the shank 14 and aligned holes 44 in the trowel blade 102. The rivets 50 illustrated in this embodiment have a first end 52 of the rivet 50 disposed in and compressed into a countersink 38 formed in the exposed side 30 of the shank 14 and a second end 54 disposed in and often compressed into a countersink 46 formed in the operational surface 18 of the trowel blade 102. Those first and second ends may be oriented in reverse in the shank 14 and finishing element 16 or otherwise oriented as desired. The rivets 50 are expanded in the plane of the exposed surface 30 of the shank 14, may be flattened to or beneath the exposed side 30 of the shank 14, may be pressed into the countersink 38 on the exposed side 30 of the shank 14. The rivets 50 may be ground, possibly until they are even with the exposed surface 30 of the shank 14. The rivets 50 may be similarly manipulated in the finishing element 16 countersinks 46.

In the embodiment illustrated in FIG. 4, a finishing trowel 100 type of hand tool 10 is provided that includes a shank 14 that is attached to a handle 12 and also attached to a trowel style 102 finishing element 16. In that embodiment, the finishing element 16 is affixed to the shank 14 by a plurality of fasteners 20. To accomplish that affixation, holes 36 through the shank 14 are aligned with holes 44 through the finishing element 16 and a fastener 20 is placed through each aligned shank 14 hole 36 and finishing element 16 hole 44.

A countersink 38 is created in the exposed side 30 of the shank 14 at each hole 36 in the exposed side 30 of the shank 14 and another countersink 46 may also be created in the operational surface 18 of the finishing element 16 at each hole 44 in the finishing element 16. When assembled, one of the fasteners 20 extends substantially through each hole 44 in the finishing element 12 and also extends substantially through an aligned hole 36 in the shank 14. A first end 62 of the fastener 20 is situated in the operational surface 18 of the finishing element 16 and a second end 64 of the fastener 20 is disposed in a countersink 56 in the exposed side 30 of the shank 14.

In embodiments wherein the fastener 20 is a rivet 50, after each rivet 50 is situated in an aligned shank 14 hole and finishing element 12 hole 44. The first end 52 of each rivet 50 is expanded across or pressed into the countersink 38 in the aligned hole 36 in the shank 14. That first end 52 of one or more of the rivets 50 may then be ground so as not extend past the exposed side 30 of the shank 14 and, preferably, to be even with the exposed side 30 of the shank 14. Such disposition of the rivets 50 may have multiple benefits, including preventing the shank 14 and attached handle 12 from becoming disconnected from the finishing element 12 and preventing a user's hand from rubbing or scraping against the fastener 20.

The second end 64 of each fastener is directed through the shank 14 toward the handle 12. In prior hand tools that use a handle shank 14 to connect the handle 12 to the finishing element 16, fasteners 20 often extend past the shank 14 and spread over the exposed side 30 of the shank 14 to get purchase on and grip the shank 14, thereby to keep the fasteners 20 engaged to the shank 14 and to minimize the likelihood that the fasteners 20 will pull out of the shank 14 during use. Hand tools are further manipulated regularly, often continuously for hours, and the user's hand is likely to impinge upon the near, exposed side 30 of the shank 14 through which the fasteners 20 are extending. Such contact between the user's hand and one or more fasteners 20 extending from the shank 14 is likely to cause harm to the user's hand and damage any glove worn by the user and is a significant complaint of those who use such trowels regularly.

Because of the proximity of the fasteners to the handle 12 and the hand, whether the hand is gloved or not, of a user of the hand tool 10, there is a danger of a hand or glove catching on or being scraped and damaged by a fastener 20 that protrudes past the shank 14. A common complaint of concrete finishers is the damage done to their hands when a finisher's hand rubs repeatedly against fasteners 20 that extend past a finishing trowel 100 shank 14 day after day. Such rubbing of the hand against the fasteners 20 can cause great harm to the dominant hand of finishers. Finishers can wear a glove on a finishing hand, but finishers complain that (i) the glove snags and grabs on the finishing trowel 100 shank 14, ruining the gloves and redirecting the finishing motion; (ii) that use of a glove reduces the finisher's grip on the trowel; and (iii) that a finisher does not feel the surface being finished sufficiently when wearing a glove. Contact between the user's hand or glove and one or more fasteners 20 is also likely to move the hand tool in an undesirable direction, often causing an undesired depression in the material being worked.

In an embodiment illustrated in FIG. 1, a trowel is provided that includes a shank 14, a handle 12 attached to the shank 14, and a trowel blade 102 attached to the shank 14. A rivet 50, as illustrated in FIG. 4, affixes the trowel blade 102 to the shank 14. The rivet 50 extends substantially through one of a plurality of holes 44 in the trowel blade 102 and also extends substantially through a hole 36 in the shank 14. When the rivet 50 is disposed in those aligned holes 36 and 44, the first end 52 of the rivet 50 is compressed into the countersink 46 in the trowel blade 102, spreading the first end 52 of the rivet 50 into the countersink 46 radially outward, making the rivet end 52 too wide to be pulled through the trowel blade hole 44. The second end 54 of the rivet 50 is similarly compressed into the countersink 38 in the exposed side 30 of the shank 14, spreading the second end 54 of the rivet 50 into the countersink 38 radially outward, making the second rivet end 54 too wide to be pulled through the shank hole 36. In that way, the rivet 50 is securely situated in the countersinks 38 and 46 and secures the handle 12 shank 14 to the finishing element 16.

In addition, the rivet 50 is not permitted to extend out of the countersink 38 beyond the exposed surface 30 of the shank 14. That may be accomplished by pressing the entire rivet 50 into the countersink 38 using a rivet gun, by peening or hammering the rivet 50 end 54 into the countersink 38, by pressing the rivet 50 in a clamp or vice, or otherwise as desired. The rivet 50 may also be ground, shaved, cut or otherwise reduced in size to eliminate any rivet 50 extending past the exposed surface 30 of the shank 14. Thus, the rivet 50 may be expanded in the plane of the exposed surface 30 of the shank 14, flattened to the exposed surface 30 of the shank 14, pressed into the countersink 36 on the exposed surface 30 of the shank 14, and/or ground or otherwise reduced so as not to extend past the exposed surface 30 of the shank 14 that faces the handle 12 and away from the finishing element 16.

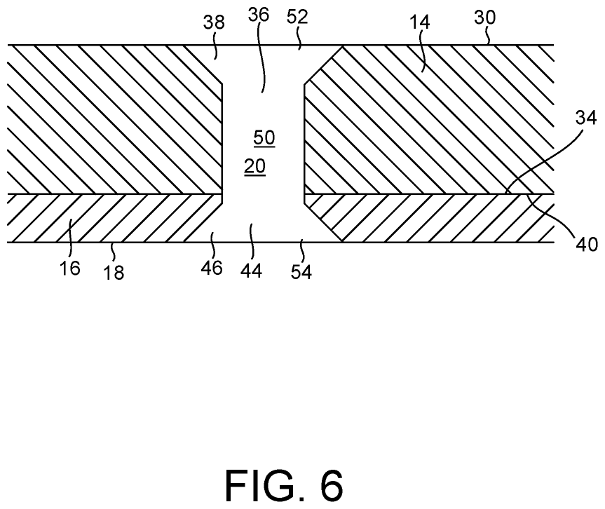

FIG. 6 illustrates a detail side view cutaway of a shank and finishing element at a fastener hole. In that detail, a rivet 50 or other fastener 20 extends through aligned holes 36 in the shank 14 and 44 in the finishing element 16. The adjacent side 34 of the shank 14 and the top face 40 of the finishing element 16 are placed together when aligning the holes 36 and 44 and countersinks 38 and 46 are formed in the exposed side 30 of the shank 14 and the operational surface 18 of the finishing element 16, respectively. The first end 52 of the rivet 50 is preferably ground, smoothed, or otherwise reduced to be even with the exposed side of the shank 14 and the second end 54 of the rivet 50 is preferably ground, smoothed, or otherwise reduced to be even with the operational surface 18 of the finishing element 16.

The handle 12 may be attached to the shank 14 in various ways. The shank 14 may include the handle coupling 48 to enable or simplify coupling the handle 12 to the shank 14. The handle 12 may be coupled to the shank handle coupling 48 by interference fit, by screwing the handle to the shank handle coupling 48, or in another desired way.

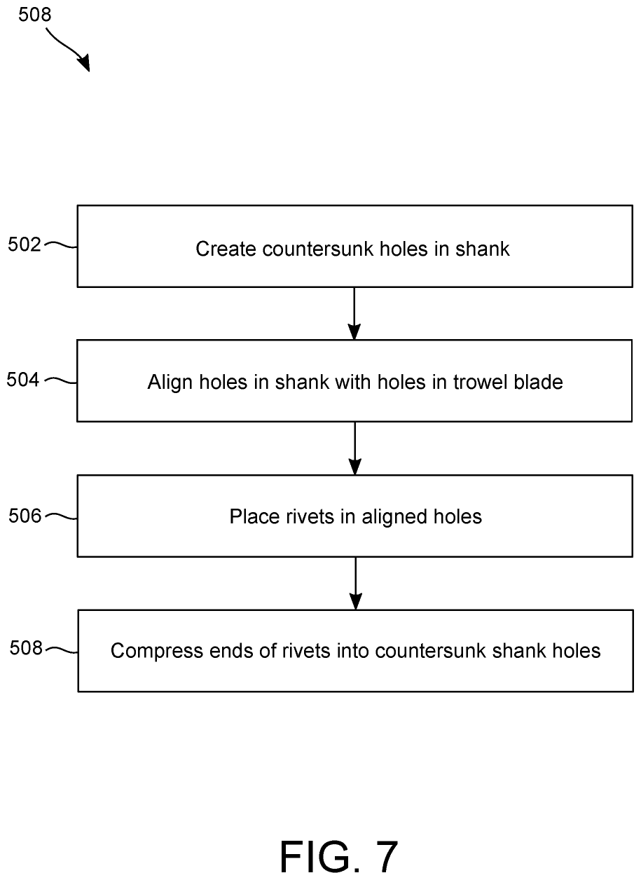

FIG. 7 illustrates a method 500 of affixing a handle shank 14 to a trowel blade 102. At 502, a countersink 38 is created in each of a plurality of holes 36 in the handle shank 14. At 504, the plurality of holes 36 in the handle shank 14 are aligned with a plurality of holes 44 in a trowel blade 102. At 506, a plurality of rivets 50 are placed in the aligned holes 36 and 44 such that each rivet 50 extends through a handle shank hole 36 and a trowel blade hole 44. At 508, an end 52 of each of the plurality of rivets 50 is compressed into the shank 14 countersink 38 in each of the plurality of holes 36 in the handle shank 14. The end 52 of each rivet 50 may be compressed, ground or otherwise reduced until the rivets 50 do not extend past the exposed surface 30 of the handle shank 14.

In certain embodiments of the method 500, at 502, the plurality of countersinks 38 may be created in the exposed surface 30 of the handle 12 shank 14, each countersink 38 being concentric with one of a plurality of holes 36 and extending from the exposed surface 30 to an opposed surface 34 adjacent to the trowel blade 102. At 504, the plurality of holes 36 in the handle 12 shank 14 may be aligned with a plurality of holes 44 in the trowel blade 102 with the shank 14 countersinks 38 exposed.

In embodiments, a second end 54 of each of the plurality of rivets 50 may be compressed into a countersink 46 formed in the operational surface 18 of the trowel blade 102 until the rivets 50 do not extend past the operational surface 18 of the trowel blade 102. Additionally, in certain embodiments, the countersink 38 in one or more of the plurality of holes 36 in the handle 12 shank 14 may be filled if the rivet 50 does not fill the countersink 38 or 46 completely. Such countersink 38 filling with filling material may beneficially smooth the riveted countersinks 38 such that the hand of a user of the finishing trowel 100 who is grasping the handle 12 and working a material with the finishing trowel 100 will not scrape against the countersinks 38 or the rivets 50 in the countersinks 38. That filling material 56 may be any desired and may include a metal, such as lead, a plastic, or another material with a lower melting temperature than the material from which the shank 14 is formed, a material that bonds well to the shank 14 material and the rivet 50 material, and a material that flows into the countersinks 38 and creates a smooth surface when it cools and solidifies.

In certain embodiments, the rivets 50 may be smoothed, for example to be even with the exposed surface 30 of the shank 14. Such smoothing may be accomplished by way of grinding, sanding, polishing, cutting, or otherwise as desired. A coating material such as paint or powder coating may be applied over the shank 14 and rivets 50, whether the countersinks 38 are filled or unfilled, to provide a smooth surface and protect the hand or glove of a user.

The finishing element 16 in the embodiment illustrated in FIGS. 1-5 also includes a front edge 22 and a back edge 24, a first side 26 and a second side 28. The top face 40 of the finishing element 16 may be generally flat and parallel to the operational surface 18 of the finishing element 16. The top face 40 may be otherwise shaped as desired to create a surface appropriately shaped for attachment of the handle shank 14. The operational surface 18 of the finishing element 16 may be shaped as desired to create a desired surface or texture. The top face 40 may include one or more projections to improve the sturdiness of the finishing element 16.

The handle 12 and shank 14 described herein may be attached as described herein to various types of trowels and finishing tools including, for example, a hand float, a bull float, or what is commonly referred to as a Fresno trowel.

The foregoing description has been directed to specific embodiments of this invention. It will be apparent, however, that other variations and modifications may be made to the described embodiments, with the attainment of some or all of their advantages. For example, fasteners, such as rivets, may be used to affix handles 12 directly to finishing elements 16 where appropriate and where use of a shank 14 is deemed unnecessary. In other embodiments, the handle 12 may be coupled to the finishing element 16 using apparatuses and methods described herein through the use of an intermediate plate or through the use of a bracket rather than a shank 14.

It will also be appreciated that features described with respect to one embodiment may be applied to another, whether explicitly indicated. Therefore, it is the object of the appended claims to cover all such variations and modifications as come within the true spirit and scope of the invention.

What is claimed is:

1. A hand tool, comprising:
a shank;
a handle attached to the shank; and
a finishing element attached to the shank by a fastener extending substantially through a hole in the finishing element and extending substantially through a hole in the shank that is aligned with the hole in the finishing element, the fastener affixing the finishing element to the shank, the fastener having a first end situated in a countersink in an exposed surface of the shank and expanded to be wider than the hole in the shank.

2. The hand tool of claim 1, wherein the handle is interference fit onto the shank.

3. The hand tool of claim 1, wherein the hand tool is a masonry tool.

4. The hand tool of claim 1, wherein the hand tool is a concrete-finishing tool.

5. The hand tool of claim 1, wherein the hand tool is a trowel.

6. The hand tool of claim 1, wherein the fastener further has a second end situated in a countersink in the finishing element.

7. The hand tool of claim 6, wherein the second end of the fastener is expanded in the countersink in the finishing element.

9. The hand tool of claim 1, wherein the shank is a rectangular cross-section bar having a plurality of holes and a countersink in each hole on an exposed surface of the shank.

10. The hand tool of claim 9, wherein the exposed surface of the shank is directed toward the handle and away from the finishing element.

11. The hand tool of claim 10, wherein the fastener is ground to the level of the exposed surface of the shank.

12. The hand tool of claim 11, wherein the fastener is a rivet and the rivet is expanded in the plane of the exposed surface of the shank, flattened to or below the exposed surface of the shank, and ground smooth with the exposed surface of the shank.

13. A trowel comprising:
a handle;
a trowel blade;
a shank attached to the trowel blade and to which the handle is attached by interference fit, the shank having an exposed surface facing the handle and facing away from the trowel blade; and
a plurality of rivets, each rivet affixing the trowel blade to the shank;
each rivet extending substantially through a hole in the trowel blade and extending substantially through an aligned hole in the shank;
each rivet having a first expanded end situated in a trowel blade countersink formed in an operative surface of the trowel blade coaxial with one of the holes in the trowel blade such that each of the plurality of rivets does not extend past the operative surface of the trowel blade; and
each rivet having a second expanded end situated in a shank countersink in an exposed surface of the shank coaxial with one of the holes in the shank such that each of the plurality of rivets does not extend past the exposed surface of the shank.

15. The trowel of claim 14, wherein each rivet is ground smooth with the exposed surface of the shank.

16. A method of affixing a handle shank to a trowel blade comprising:
creating a plurality of countersinks in an exposed surface of a handle shank, each countersink concentric with one of a plurality of holes extending from the exposed surface to an opposed surface;
aligning the plurality of holes in the handle shank with a plurality of holes in a trowel blade with the shank countersinks exposed;
placing a plurality of rivets through the aligned handle shank holes and trowel blade holes so that each rivet extends through one of the handle shank holes and one of the trowel blade holes;
compressing a first end of each of the plurality of rivets into the countersink in each of the plurality of holes in the handle shank; and
grinding each of the plurality of rivets so that the rivets do not extend past the exposed surface of the handle shank.

17. The method of claim 16, further comprising compressing a second end of each of the plurality of rivets into a countersink formed in an operational surface of the trowel blade until the rivet does not extend past the operational surface of the trowel blade.

18. The method of claim 16, further comprising grinding each of the plurality of rivets to be even with the operational surface of the trowel blade.

19. The method of claim 16, further comprising coating the exposed surface of the handle shank and the rivets that extend into the countersinks in the exposed surface of the handle shank.

20. The method of claim 16, further comprising at least one of grinding each of the plurality of rivets to be even with the exposed surface of the handle shank.
